(19) United States
(12) Patent Application Publication
(10) Pub. No.: US 2009/0046907 A1
(43) Pub. Date: Feb. 19, 2009

(54) Parallel Execution Of All Image Processing Workflow Features

(75) Inventor: Prabhakant Das, Streamwood, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/024,335

(22) Filed: Feb. 1, 2008

Related U.S. Application Data
(60) Provisional application No. 60/956,496, filed on Aug. 17, 2007.

(51) Int. Cl. G06K 19/00

(52) U.S. Cl. 382/128

(57) ABSTRACT

A method of parallel execution of image processing, having steps of acquiring at least one image from a patient, choosing a workflow to view the at least one image from the patient, processing the at least one image from the patient in at least two different workflows in parallel, and displaying the at least one image from the patient, wherein a user may view the at least one image from the patient in any different workflow processed.

### CROSS-REFERENCE TO RELATED APPLICATIONS

The present application claims priority to U.S. Provisional Application 60/956,496 filed Aug. 17, 2007, the entirety of which is incorporated by reference.

### FIELD

The present invention relates to image processing. More specifically, the present invention relates to parallel execution of image processing workflow features.

### BACKGROUND INFORMATION

During the start of an image acquisition phase in conventional image processing laboratories, the systems used offer a number of different choices displaying images. These choices are known as “workflows” or “flows” within the system. The images that are displayed on the system are the result of the application performing an “image processing function” on the acquired images according to the selected “flow”. If a different “flow” is desired, the new “flow” needs to be selected, and either the acquisition has to be restarted anew or the same images need to be played back with that new flow activated so that the flow can perform the image processing function.

There are several significant problems with single flow based processing of images. First, there is time lost in applying a different image processing function later on the same set of images. Second, if two sets of acquisitions are performed, it is unlikely that both sets of images will be the same. Third, it is hard to correlate the resulting images at a specific point in time as a result of performing two different image processing functions on the same sets of images for the same period of time.

Conventionally, the only method to achieve such a processing function is to perform a playback of the images with different image processing turned on, one after another. This process, however, can not be done during the image acquisition phase.

There is a need to provide a method and system to allow for parallel execution of different image processing functions on medical images of patients.

There is a further need to provide a method and system to economically produce and parallel process images.

### SUMMARY

It is therefore an objective of an aspect of the present invention to provide a method and system to allow for parallel execution of medical images of patients.

It is a further objective of an aspect of the present invention to provide a method and system to economically produce and parallel process images.

The objectives of the present invention are achieved as illustrated and described. In an exemplary embodiment of the invention, a method of parallel execution of image processing is provided comprising, acquiring at least one image from a patient, choosing a workflow to view the at least one image from the patient, processing the at least one image from the patient in at least two different workflows in parallel, and displaying the at least one image from the patient, wherein a user may view the at least one image from the patient in any different workflow processed.

In an alternative embodiment of the present invention, a method is presented as recited above wherein the image is obtained from a medical procedure.

In another alternative embodiment of the present invention, the method may also be accomplished such that the displaying of the at least one image is on a computer monitor.

In another alternative embodiment of the present invention, the method may be accomplished such that the displaying of the at least one image is on a PACs machine.

In a still alternative embodiment of the present invention, the method may be accomplished such that the processing of the at least one image from the patient in at least two different workflows in parallel is performed on at least five images.

In another alternative embodiment of the invention, a program storage device readable by machine, tangibly embodying a program of instructions executable by the machine to perform method steps to perform parallel execution of image processing is presented. The method comprises the steps of acquiring at least one image from a patient, choosing a workflow to view the at least one image from the patient, processing the at least one image from the patient in at least two different workflows in parallel, and displaying the at least one image from the patient, wherein a user may view the at least one image from the patient in any different workflow processed.

In an alternative embodiment of the present invention, the program storage device is presented as recited above, wherein the image is obtained from a medical procedure.

In another alternative embodiment of the present invention, the program storage device may also be configured such that the displaying of the at least one image is on a computer monitor.

In another alternative embodiment of the present invention, the program storage device may be configured such that the displaying of the at least one image is on a PACs machine.

In a still alternative embodiment of the present invention, the program storage device may be configured such that the processing of the at least one image from the patient in at least two different workflows in parallel is performed on at least five images.

In another alternative embodiment, the method may be accomplished such that the processing of the at least one image from the patient in at least two different workflows in parallel comprises displaying acquired images in a sequential pattern in a first workflow, and comparing every image to a previously taken image to produce a resultant image in a second workflow.

In another alternative embodiment, the method is accomplished such that the comparing every image to the previously taken image identifies the lightest and darkest areas at corresponding places in two images.

In another alternative embodiment, the program storage device is arranged such that the processing of the at least one image from the patient in at least two different workflows in parallel comprises displaying acquired images in a sequential pattern in a first workflow, and comparing every image to a previously taken image to produce a resultant image in a second workflow.

In another alternative embodiment, the program storage device is arranged such that the comparing of every image to the previously taken image identifies the lightest and darkest areas at corresponding places in two images.

### BRIEF DESCRIPTION OF THE DRAWINGS

FIG. 1 is a diagram of a parallel imaging processing system in conformance with the present application.

FIG. 2 is a method for parallel image processing in conformance with the present application.

FIG. 3 is an apparatus for parallel processing of images.

### DETAILED DESCRIPTION

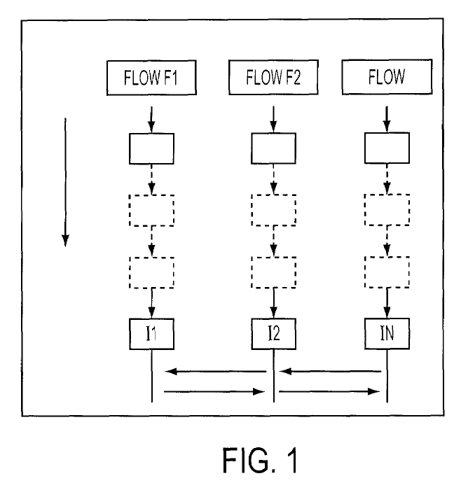

Referring to FIG. 1, a process for parallel processing of images is presented. Aspects of the present invention provide for processing of images, such as still images from x-ray, computed tomography scans, and ultrasound scans to aid a medical professional in the evaluating the status of a patient. To this end, aspects of the invention allow for retrieval and processing of images obtained during medical evaluations after the medical evaluations have been performed, or, in an alternative embodiment, during the medical evaluation itself in an economical manner previously unattained.

In a first conventional image acquisition scenario, every image that is acquired during a medical evaluation is displayed. This display is occurring in a sequential order that is reviewed by the medical professional. In an alternative image acquisition scenario, however, every image after a first image is compared to a previously obtained image. Each image pair is then compared to one another to provide for a contrasted resultant image. This resultant image highlights, for example, the lightest and/or darkest areas of a image at corresponding places. This allows a medical professional to quickly identify areas of concern in an image.

Conventional images are produced for medical professionals on the basis of providing sequential images for review by the medical professional. In the exemplary embodiments provided in the present invention, a medical professional may toggle back and forth between the standard images obtained during the medical evaluation and the contrasted images of the resultant image within the system. This provides the medical professional with additional alternatives for evaluating areas of concern within an image.

An embodiment of the present invention provides a new arrangement wherein all image processing functions are applied to a scene set of images in parallel according to different flows that are available for image processing. In the current specification, the term “flows” denotes image processing techniques that are required to be performed by the system according to a predefined set of parameters. Thus, different “flows” can be applied to a set of images to be evaluated by a medical professional. Exemplary “flows” can include, increasing contrast levels within an image in an incremental steps of 5% so that the medical professional may see clearly detailed features provided in the image. Alternatively, “flows” may also entail increasing sharpness of images were comparing different images with one another to contrast features needed to be evaluated. Additionally, “flows” can highlight different features with colored markings or notations.

An embodiment of the present invention provides for image processing functions that are applied to a set of images that have been obtained during a medical procedure and performing these processing functions in parallel. Referring to FIG. 1, all image processing flows are proceeding in parallel, as opposed to requiring a medical professional to exit a specified “flow” and begin a new separate “flow”. In an embodiment of the present invention, a medical professional has the possibility of switching between different flows without terminating or affecting the previous flow that has been worked upon. This allows for significant economic savings in not requiring the medical professional to wait for image processing and by minimizing error that may occur due to incorrect diagnosis of a patient's status. The medical professional can simply flip to any of the ongoing image processing function application flows without having to acquire new sets of images or playing the same set of images from the beginning.

As shown in FIG. 1, at some arbitrary point in time, for example, the resultant images with different flows of image processing applied are I1, I2, and IN with the different flows F1, F2, and FN respectively. In an embodiment of the present invention, the system will provide the medical professionals with the ability to switch to viewing the results I1, I2 and IN at any time without having to start with the same sets of images all over again with different flow.

An embodiment of the present invention provides many advantages over conventional systems. The present embodiment provides for time savings resulting from the parallel application of processing functions. The present embodiment also provides for greater economic costs savings as there is no need to perform a second set of data acquisition for a different image processing flow. The present invention also provides for better visualization in comparison of the resultant images, thereby minimizing error for medical professionals.

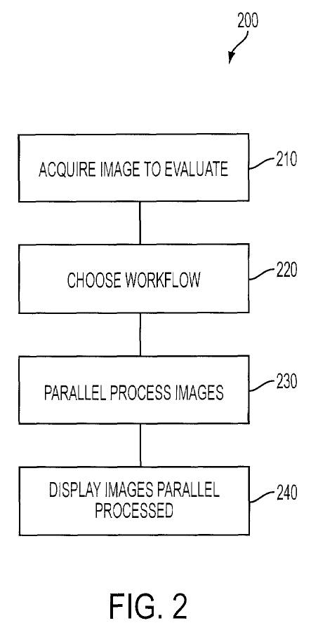

Referring to FIG. 2, a method of parallel execution of image processing is provided 200. First, the method provides for acquiring at least one image from a patient 210. Next, a workflow is chosen to view the at least one image from the patient 220. Next, at least one image is processed from the patient in at least two different workflows in parallel 230. Lastly, the at least one image from the patient is displayed, wherein a user may view the at least one image from the patient in any different workflow processed 240.

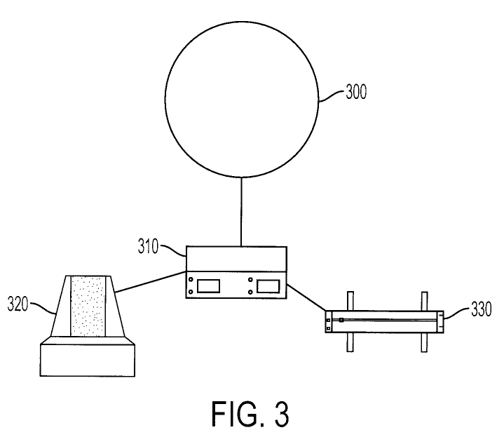

Referring to FIG. 3, a system illustrating the parallel processing arrangement is provided. In the system provided, images are obtained through an image recording device 300. As will be understood by a person of skill in the art, the image recording device 300 can include, for example, an x-ray machine, a computed tomography machine, and ultrasound machine or other applicable diagnostic device. The image recording device 300 is connected to a computer 310 that accepts data from the image recording device 300. The computer allows acceptance of the data obtained from the image recording device 300 and allows a researcher, for example, to process the images obtained for maximization of the recorded image. The computer 310 can process the image such that the contrast of the image may be enhanced or decreased as need be. Results of the image processing from the computer 310 are provided on a display 320 area similarly, images that are processed by the computer 310 may be provided to a plotter 330 further archiving.

The system provided in FIG. 3 may be augmented by including additional components for recording of the data obtained from the image recording device 300. Such components can include, for example, compact disk recording devices, additional hard disk devices, and other applicable input and/or output devices.

The method provided above may be performed such that the image is from a medical procedure performed in a doctor or dentists office, as non-limiting examples. Displaying of the information to an individual operating the device can be done on a single or dual computer monitor to allow side by side comparison of results obtained from work flows.

Although provided as a stand-alone arrangement, the system can be configured such that displaying of the at least one image is done on a PACs machine.

The method may also be configured such that the processing of the at least one image from the patient in at least two different workflows in parallel is performed on at least five images or any number of images chosen by the operator.

An embodiment of the present invention provides for a method and system to allow for parallel execution of medical images of patients and economically produces these images.

In the foregoing specification, the disclosure has been described with reference to specific exemplary embodiments thereof. It will, however, be evident that various modifications and changes may be made thereunto without departing from the broader spirit and scope of the disclosure as set forth in the appended claims. The specification and drawings are accordingly to be regarded in an illustrative rather than in a restrictive sense.

What is claimed is:

1. A method of parallel execution of image processing, comprising:
acquiring at least one image from a patient;
choosing a workflow to view the at least one image from the patient, wherein the workflow processes the at least one image;
processing the at least one image from the patient in at least two different workflows in parallel; and
displaying the at least one image from the patient, wherein a user may view the at least one image from the patient in any different workflow processed.

2. The method according to claim 1, wherein the image is from a medical procedure.

3. The method according to claim 1, wherein the displaying of the at least one image is on a computer monitor.

4. The method according to claim 1, wherein the displaying of the at least one image is on a PACs machine.

5. The method according to claim 1, wherein the processing of the at least one image from the patient in at least two different workflows in parallel is performed on at least five images.

6. The method according to claim 1, wherein the processing of the at least one image from the patient in at least two different workflows in parallel comprises:
displaying acquired images in a sequential pattern in a first workflow; and
comparing every image to a previously taken image to produce a resultant image in a second workflow.

7. The method according to claim 6, wherein the comparing every image to the previously taken image identifies the lightest and darkest areas at corresponding places in two images.

8. A program storage device readable by machine, tangibly embodying a program of instructions executable by the machine to perform method steps to perform parallel execution of image processing, comprising
acquiring at least one image from a patient;
choosing a workflow to view the at least one image from the patient;
processing the at least one image from the patient in at least two different workflows in parallel; and
displaying the at least one image from the patient, wherein a user may view the at least one image from the patient in any different workflow processed.

9. The program storage device according to claim 8, wherein the image is from a medical procedure.

10. The program storage device according to claim 8, wherein the displaying of the at least one image is on a computer monitor.

11. The program storage device according to claim 8, wherein the displaying of the at least one image is on a PACs machine.

12. The program storage device according to claim 8, wherein the processing of the at least one image from the patient in at least two different workflows in parallel is performed on at least five images.

13. The program storage device according to claim 8, wherein the processing of the at least one image from the patient in at least two different workflows in parallel comprises:
displaying acquired images in a sequential pattern in a first workflow; and
comparing every image to a previously taken image to produce a resultant image in a second workflow.

14. The program storage device according to claim 13, wherein the comparing every image to the previously taken image identifies the lightest and darkest areas at corresponding places in two images.
